(19) United States
(12) Patent Application Publication
(10) Pub. No.: US 2006/0043739 A1
(43) Pub. Date: Mar. 2, 2006

(54) Securing device for inside container door

(76) Inventor: Roy E. Gogel, Greenville, SC (US)

Correspondence Address: John B. Hardaway, III;NEXSEN PRUET JACOBS & POLLARD, LLC, P.O. Box 10107, Greenville, SC, 29603, US

(21) Appl. No.: 11/168,041

(22) Filed: Jun. 28, 2005

Related U.S. Application Data
(60) Provisional application No. 60/605,444, filed on Aug. 30, 2004.

(51) Int. Cl. E05C 1/04

(52) U.S. Cl. 292/148

(57) ABSTRACT

An auxiliary locking device for a door of a cargo container having a vertical wall of a U shaped bracket secured to the inner side of the door and having a locking bolt which, in its locking position, has a cylindrical portion extending through aligned openings in upper and lower walls of the bracket and into a vertical hole in the container floor. The bolt is retained in its locking position by a removable clip type cotter pin and is tethered to the bracket to prevent misplacement.

### RELATED PATENT APPLICATION

Features of the invention disclosed herein are disclosed in U.S. provisional patent application Ser. No. 60/605,444 filed Aug. 30, 2004 for an Inner Bolt for Cargo Container Door, the benefit of which is claimed.

### BACKGROUND OF THE INVENTION

This is a device for preventing unauthorized opening of the left or passive door of a cargo container of the type used on truck trailers or storage containers. Such containers customarily have two side-by-side doors hinged to laterally opposite sides of the rear of the container on vertical axes and the doors are latched in their closed position by vertical stanchions or locking rod assemblies mounted on the outside of the doors. The locking rod assemblies have latching fingers at their tops and bottoms, which engage keeper pockets at the top and bottom of the rear of the container when the locking rod assemblies are pivoted about their axes. Securing devices are typically installed on the outside of the right or active door and, in some instances, across the two doors.

### SUMMARY OF THE INVENTION

The security device of this invention retains the left or passive door in its closed position, preventing that door from being opened. The device is semi-permanent, being secured to the inside of the door by releasable fasteners such as screws. It includes a U shaped bracket having aligned guide holes for a locking bolt in its vertically spaced flanges and openings in its vertical web for the fasteners. In its locking position the locking bolt passes through the guide holes and into a hole drilled in the bottom of the container or tractor-trailer. The locking bolt is held in its engagement or locking position by a releasable spring clip type cotter pin.

### BRIEF DESCRIPTION OF THE DRAWINGS

FIG. 1 is a perspective view of the rear end of the cargo container of a semi-trailer truck;

FIG. 2 is a partial horizontal section taken on the line 2-2 in FIG. 1;

FIG. 3 is a section taken on line 3-3 in FIG. 2, and

FIG. 4 is a perspective view of the securing device with components in exploded positions.

### DETAILED DESCRIPTION OF THE INVENTION

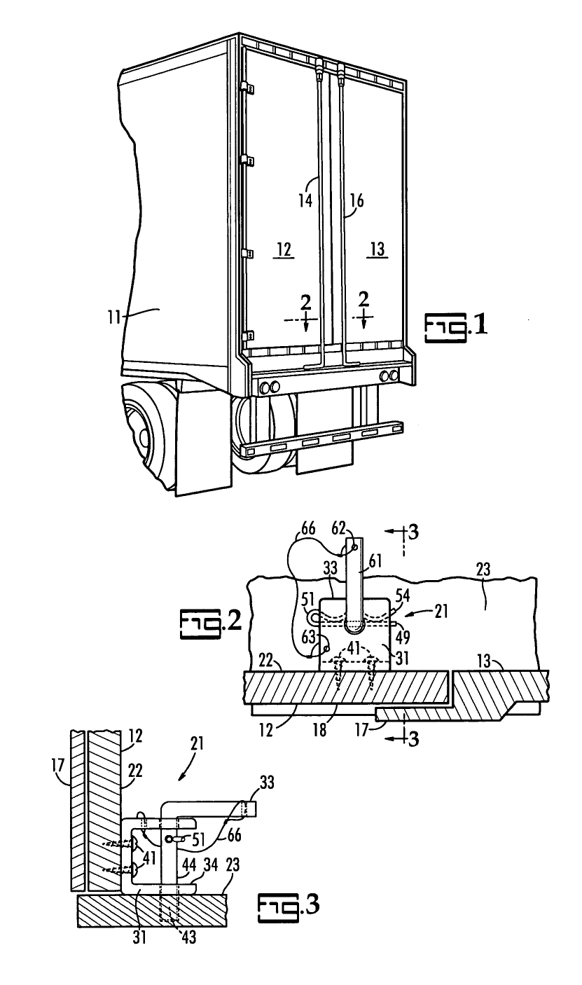

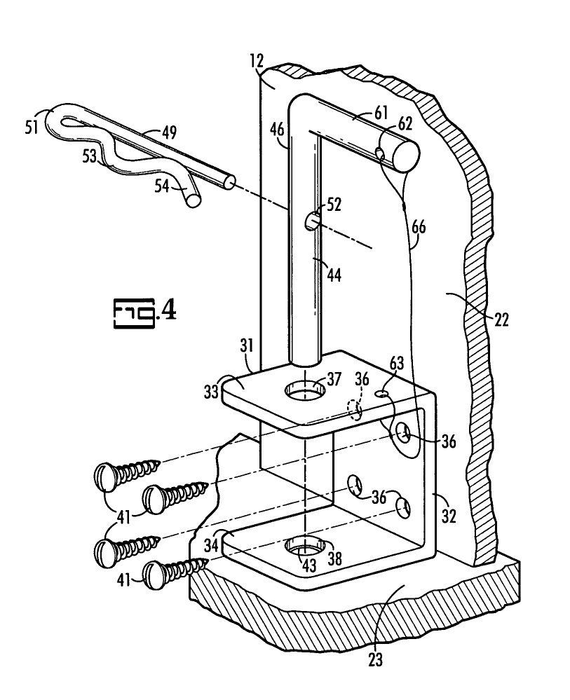

The cargo container 11 shown in FIG. 1 has a left or passive door 12 on the left hand side of the truck and an active or right door 13 on the right hand side of the truck. The rearwardly opening doors 12, 13 are hinged on parallel vertical axes to laterally opposite sides of the cargo container and are releasably locked by a pair of parallel vertical stanchions 14, 16 having keepers on their opposite ends which engage and disengage pockets at the top and bottom of the container 11 when rotated about their longitudinal or vertical axes. The right door 13 includes an offset lip 17 extending laterally in overlapping relation to the rear side 18 of the left door 12, which prevents the left door 12 from being opened unless the right door 13 is opened.

As shown in the drawings, a securing device 21 is provided on the inner side 22 of the passive or inside door 12 for releasably locking the passive door to the floor 23 of the cargo container 11. The securing device 21 includes a steel U shaped bracket 31 having a vertical wall or web 32 and vertically spaced parallel horizontal flanges in the form of an upper wall 33 and a lower wall 34. The upper and lower walls 33, 34 are rigidly secured at their rear ends to the top and bottom ends of the vertical wall 32 and extend horizontally toward the front of the container. Four mounting holes 36, forming a quadrilateral pattern, are drilled in the vertical wall 32 and a pair of vertically aligned annular holes 37, 38 are drilled in the upper and lower walls 33, 34, respectively. The bracket 31 is secured to the inside of the left door 12 by four releasable fasteners in the form of screws 41, which extend through the openings 36 and are threaded into suitable openings in the door 12. In the illustrated closed position of the door 12, the openings 37, 38 align with a vertically extending cylindrical hole 43 in the floor 23 of the container 11. A cylindrical portion 44 of an L shaped locking bolt 46 is passed through the aligned openings 37, 38 of the bracket 31 and into the floor opening 43, thereby locking the closed door 12 to the container 11.

After placing the locking bolt 46 in its locking position, the straight leg 49 of a clip type cotter pin 51 is passed through a transverse opening 52 in the cylindrical portion 44 and an arch 53 in a bent leg 54 of the cotter pin 51 registers with the cylindrical portion 44 of the bolt 46, thus releasably retaining the cotter pin 51 on the bolt 46. The cotter pin prevents upward withdrawal movement of the bolt 46, which might otherwise occur from vibration during highway travel. The L shaped locking bolt 46 includes an arm 61 extending at a right angle to the upper end of the cylindrical portion 44. A hole 62 is formed in the distal end of the arm 61 and a hole 63 is formed in the upper wall 33. Opposite ends of a tether cable 66 are passed through the openings 62, 63 respectively, and secured in loops by bent metal clips, thus preventing misplacement of the bolt 46 when it is withdrawn from the bracket 31.

The herein disclosed auxiliary locking device helps to stabilize the left cargo container door, thus making it more difficult for thieves to pry open the doors of the container. It is inexpensive and easy to install, thus making it a cost effective deterrent to a cargo container break-in.

What is claimed is:

1. In combination with a cargo container having a floor, laterally opposite sides and side-by-side passive and active doors hinged, respectively, on vertical axes to the laterally opposite sides, a locking device for presenting pivotal movement of said passive door between closed and open positions, comprising:
a bracket including
a vertical wall having a lower end and on upper end,
a bottom wall rigidly secured to and extending horizontal in a predetermined direction from said lower end of said vertical wall,
a top wall rigidly secured to and extending horizontally in said predetermined direction from said upper end of said vertical wall,
a plurality of horizontally extending openings in said vertical wall adapted to receive releasable fasteners, and
a pair of vertically aligned openings in said upper wall and said lower wall, respectively,
releasably fasteners extending through said horizontally extending openings in said back wall and releasably securing said bracket to said passive door,
a vertically extending hole in said container floor aligned with said vertically aligned openings in said bracket when said passive door is in its closed position, and
a bolt having a cylindrical portion adapted to extend through said vertically aligned openings in said upper and lower walls of said bracket and into said hole in said floor in a locking position whereby said passive door is releasably locked in its closed position.

2. The combination of claim 1 wherein said cylindrical portion of said bolt has a transverse opening disposed below said upper wall when said bolt is in said locking position and further comprising a clip type cotter pin having a straight leg extending through said transverse opening, said cotter pin releasably retaining said bolt in its locking position.

3. The combination of claim 2 wherein said bolt includes an arm extending at a right angle from the upper end of said horizontal portion.

4. The combination of claim 3 wherein said arm of said bolt is tethered to said bracket.

5. The combination of claim 1 wherein said bolt is tethered to said bracket.

6. The combination of claim 1 wherein said bracket is U shaped.
